(19) United States
(12) Patent Application Publication
(10) Pub. No.: US 2014/0156142 A1
(43) Pub. Date: Jun. 5, 2014

(54) System and method for automatic control of the ride height setting on a road-going vehicle

(71) Applicants: Ronald S. Patrick, Mountain View, CA (US); Alan R. Eaton, Cupertino, CA (US)

(72) Inventors: Ronald S. Patrick, Mountain View, CA (US); Alan R. Eaton, Cupertino, CA (US)

(73) Assignee: Engine Control and Monitoring, Los Altos, CA (US)

(21) Appl. No.: 13/815,145

(22) Filed: Feb. 4, 2013

Related U.S. Application Data
(60) Provisional application No. 61/797,148, filed on Nov. 30, 2012.

(51) Int. Cl. B60G 17/015

(52) U.S. Cl. CPC B60G 17/015
USPC 701/37

(57) ABSTRACT

A method for automatically controlling the ride height system of a road going vehicle, based on the proximity of the vehicle to specified waypoints defined by the user. Waypoints are added or deleted by the user via a user interface. A program loop continually checks the proximity of the road going vehicle to the waypoints defined by the user and triggers the vehicle ride height system when the vehicle approaches a stored waypoint.

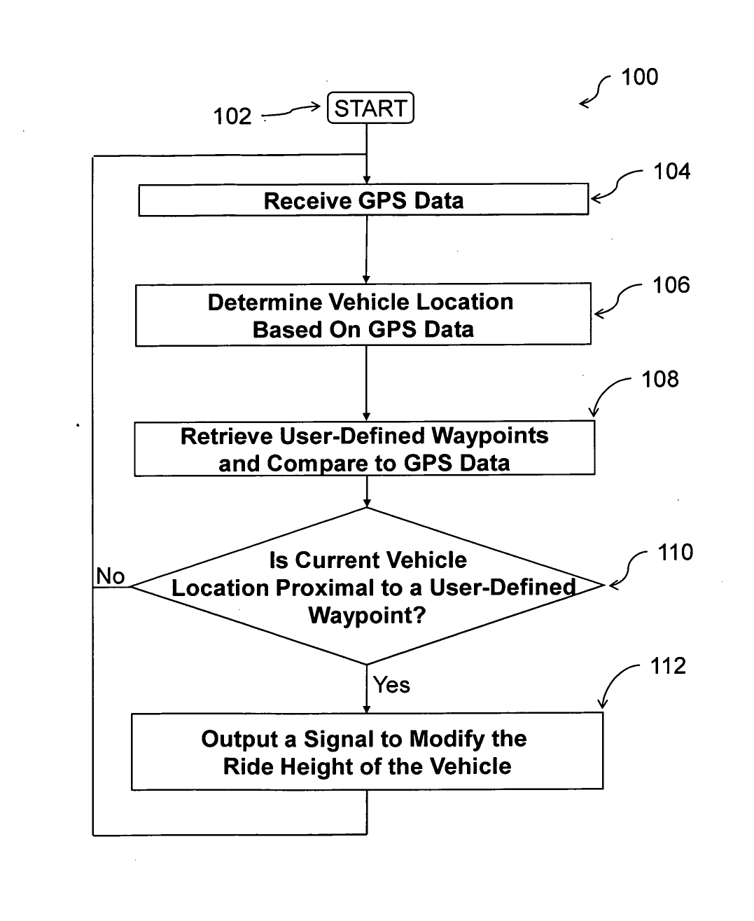

### CROSS-REFERENCE TO RELATED APPLICATIONS

The present application is submitted with reference to, and claims the benefit of, provisional patent application U.S. 61/797,148 filed on Nov. 30, 2012. The title of the cited provisional application is “System and Method for Automatic Control of the Ride Height Setting on a Road-Going Vehicle”. The text of the first sentence following the title of the specification of the cited provisional patent application is “The operating characteristics of a road-going vehicle are those features of a road-going vehicle that effect performance of the road-going vehicle, are variable, and outside the domain of steering, acceleration and braking inputs.”.

### STATEMENT REGARDING FEDERALLY SPONSORED RESEARCH

(Not Applicable)

### BACKGROUND OF THE INVENTION

The operating characteristics of a road-going vehicle are those features of a road-going vehicle that effect performance of the road-going vehicle, are variable, and outside the domain of steering, acceleration and braking inputs. Examples include ride height control systems, suspension control systems and traction control systems. At the present time there is a lot of development work in the fields of geo-fencing for mobile communications devices, automatic control of the operating characteristics of road-going vehicles based on vehicle sensor information, location triggers for actuation of off-highway vehicle hardware, and driverless cars that can accelerate, brake and turn based on a combination of GPS data vehicle sensor data. While there has been a significant confluence of these technologies in recent years, there is still no method disclosed in prior art that allows for automatic control of one or more operating characteristics of a road-going vehicle based on the current proximity of the road-going vehicle to user-defined waypoints.

### BRIEF SUMMARY OF THE INVENTION

The disclosed invention incorporates GPS data with user-defined waypoints to automatically control the ride height system of road-going vehicles. A practical embodiment of the invention might be the automatic actuation of a ride height system based at a user-defined waypoint, inputted though the driver interface of the road-going vehicle, in order to avoid scraping the undercarriage of the road-going vehicle on an obstacle such as a speed bump. Another practical embodiment might be the use of software flags that allow for the automatic actuation of systems in the road-going vehicle, triggered at a user-defined waypoint, or at a certain proximity from a user-defined waypoint.

### BRIEF DESCRIPTION OF THE DRAWING

The enclosed figure is a system level block diagram of one possible practical embodiment of the invention demonstrating the basic steps of a software loop to automatically control the ride height system of a road going vehicle that a person skilled in the applicable arts would need to build a working example of the invention.

### DETAILED DESCRIPTION OF THE INVENTION

The present invention relates generally to vehicle control, and, more specifically, to systems and methods for automatically controlling the ride height system of a road-going vehicle using Global Positioning System (GPS) data in conjunction with user-defined waypoints.

Embodiments are directed generally to a system and method for controlling the ride height system of a road-going vehicle. In particular, various embodiments can comprise a system and method for controlling the ride height system of the road-going vehicle comprising a global positioning system (GPS) receiver that receives, at the road-going vehicle, GPS data; a controller coupled to the GPS receiver and a street map data storage unit that locally stores street map information, where the controller is configured to determine a location of the road-going vehicle based on received GPS data; a user interface that allows input of user-defined waypoints; identification of user-defined waypoints proximal with the determined location of the road-going vehicle; and output at least one signal to modify, based on the proximity of user-defined waypoints to the location of the road-going vehicle, the ride height system of the road-going vehicle.

One embodiment might comprise the automatic actuation of the ride height system of a road-going vehicle in order to increase the ground clearance over an obstacle, known to the user, who has previously set a user-defined waypoint via the user interface of the road-going vehicle, in order to avoid scraping the undercarriage of the road-going vehicle when the road-going vehicle is in close proximity to the obstacle represented by the user-defined waypoint.

Referring now to the enclosed figure a system level block diagram represents a software loop 100 with a start condition 102. GPS data is received 104 and read into the system following the start condition 102. The location of the vehicle is determined 106 from the received GPS data 104. User-defined waypoints 108 are retrieved and compared to the vehicle location 106. A true or false condition of the vehicle being proximal to a user-defined waypoint is tested 110, the resulting tested value setting the system to either the start condition 102 in the case of a negative result, or outputting a signal 112 to modify the ride height system of the vehicle and setting the system back to the start condition 102.

While the present invention has been described in conjunction with one possible embodiment, the invention is not to be limited to the description of the embodiment contained herein, but rather is defined by the claims appended hereto and their equivalents. It is further evident that many alternatives, modifications and variations would be apparent to those of ordinary skill in the applicable arts. Accordingly, all such alternatives, modifications, equivalents, and variations that are within the spirit and scope of this invention.

1. A method for automatically controlling the ride height system of a road-going vehicle comprising: receiving, at a road-going vehicle, global positioning system (GPS) data determining a location of said road-going vehicle based on said received GPS data; a user interface allowing user-defined waypoints; retrieving said user-defined waypoints; and automatically modifying the ride height system of said road-going vehicle; based upon the proximity of said road-going vehicle to said user-defined waypoints.

2. A method for automatically controlling the ride height of a road-going vehicle comprising: receiving, at a road-going vehicle, global positioning system (GPS) data determining a location of said road-going vehicle based on said received GPS data; a user interface allowing user-defined waypoints; retrieving said user-defined waypoints; actuators to actuate the ride height of said road-going vehicle; automatically modifying the ride height of said road-going vehicle, based upon the proximity of said road-going vehicle to said user-defined waypoints.

3. The method for controlling operating characteristics according to claim 1, wherein said user-defined waypoints are imputed directly through the said user interface of said road-going vehicle.

4. The method for controlling operating characteristics according to claim 1, wherein said user-defined waypoints are automatically compared at set intervals to said received GPS data; and allowing for a user-defined proximity trigger allowing changes to said ride height system.

5. The method for controlling the ride height system according to claim 1, wherein said user-defined waypoints can be associated with flags in said user interface that specify changes in said ride height system; based upon the proximity of said road-going vehicle to said user-defined waypoints.

6. The method for controlling the ride height system according to claim 1, wherein said user-defined waypoints are automatically compared at set intervals to said received GPS data; and allowing for a user-defined variable proximity trigger considerate of the current speed of said road-going vehicle approaching said user-defined waypoints, modifying said ride height system of said road going vehicle.

7. The method for controlling the ride height system according to claim 1, wherein said user-defined waypoints are imported from an existing set of waypoints.

8. The method for controlling the ride height system according to claim 1, wherein said user-defined waypoints are imported by the user from an external source.

9. A method for automatically controlling the ride height system of a road-going vehicle comprising: receiving, at a road-going vehicle, global positioning system (GPS) data determining a location of said road-going vehicle based on said received GPS data; retrieving user-defined waypoints; and automatically modifying the ride height setting of said ride height system of said road-going vehicle, based upon a certain proximity of said road-going vehicle to said user-defined waypoints.

10. The method for controlling the ride height system according to claim 9, wherein said user-defined waypoints are imported from an existing set of waypoints.

11. The method for controlling operating characteristics according to claim 9, wherein said user-defined waypoints are imported by the user from an external source.

12. A system for controlling the ride height system of a road-going vehicle, said system comprising: means for wirelessly receiving location data concerning the current location of said road-going vehicle; means for storing street map information; means for determining a location of said road-going vehicle based on said received location data; means for identifying street map information associated with the determined location; means for outputting at least one signal to modify said ride height system of said road-going vehicle based on a certain proximity of said road-going vehicle to at least one user-defined waypoint.

13. A system for automatically controlling the ride height of a road-going vehicle, said system comprising: means for wirelessly receiving location data concerning the location; means for storing street map information; means for determining a location of said road-going vehicle based on said received location data; means for identifying street map information associated with the determined location; means for the user to define waypoints in the user interface of the road-going vehicle; means for comparing said determined location of the road-going vehicle to said waypoints; means for outputting at least one signal to modify the ride height of said road-going vehicle based on a defined proximity of said road-going vehicle to said user-defined waypoints.

14. The system for automatically controlling the ride height of a road-going vehicle according to claim 13, wherein said retrieved location data triggers said signal to modify said ride height of said road-going vehicle based on a variable proximity to one or more said user-defined waypoints.

15. The system for automatically controlling the ride height system of a road-going vehicle according to claim 12, wherein said means for determining is further responsive to means for measuring a distance traveled by said road-going vehicle.

16. The system for automatically adjusting the ride height of a road-going vehicle according to claim 13, wherein said means for determining is further responsive to means for measuring a predetermined time period.

17. Software, when executed by a processor, cause the processor to perform at least the following operations: receiving, at a road-going vehicle, global positioning system (GPS) data; determining a location of said road-going vehicle based on said received GPS data; retrieving user-defined waypoints; comparing said user-defined waypoints with said received GPS data; and automatically outputting a signal representing an adjustment to the ride height system of said road-going vehicle, based on a user-defined proximity of said road-going vehicle to said user-defined waypoints.

18. Software, when executed by a processor, cause the processor to perform at least the following operations: receiving, at a road-going vehicle, global positioning system (GPS) data; determining a location of said road-going vehicle based on said received GPS data; retrieving user definable waypoints; comparing said user-defined waypoints with determined location, selecting a ride height adjustment system; and automatically outputting a signal representing an adjustment to the ride height system, based on a user-defined proximity trigger of said road-going vehicle to said user-defined waypoints.

19. The computer readable medium according to claim 18, wherein said selecting comprises selecting a ride height adjustment system, and said signal represents a desired automatic adjustment to the actual ride height of said road-going vehicle responsive to the proximity of the current location of said road-going vehicle to said user-defined waypoints.
